(19) United States
(12) Patent Application Publication
(10) Pub. No.: US 2026/0157408 A1
(43) Pub. Date: Jun. 11, 2026

(54) METHOD FOR MANUFACTURING SOUP-CHICKEN

(71) Applicant: Moo-Hong MIN, Busan (KR)

(72) Inventor: Moo-Hong MIN, Busan (KR)

(21) Appl. No.: 19/410,678

(22) Filed: Dec. 5, 2025

(30) Foreign Application Priority Data
Dec. 6, 2024 (KR) 10-2024-0180196

(51) Int. Cl. A23L 13/50; A23L 13/75; A23L 23/00

(52) U.S. Cl. CPC A23L 13/50; A23L 13/75; A23L 23/00

(57) ABSTRACT

The present invention relates to a method for manufacturing soup-chicken, and more particularly, to a method for manufacturing soup-chicken that can be boiled and eaten.

### FIELD OF INVENTION

The present invention relates to a method for manufacturing soup-chicken, and more particularly, to a method for manufacturing soup-chicken that can be boiled and eaten.

### BACKGROUND OF INVENTION

Chicken has been a nutritious food favored since ancient times. Specifically, chicken meat is recognized as an excellent health food because it has a high content of protein and essential fatty acids, and relatively low fat and calorie contents compared to other meats.

Furthermore, chicken meat is inexpensive compared to other meats, quick to cook, and easy to chew, resulting in high digestibility. Moreover, its mild flavor makes it highly compatible with other spices or foods.

Although various cooking methods have been developed for this chicken meat, the most representative dish among them can be said to be chicken (fried chicken).

The above-mentioned fried chicken has a chronic problem of excessive oil content, which is too greasy for the palate of Koreans, thus revealing a limit to its growth in the Korean market. Therefore, in Korea, seasoned chicken, which is mixed with sauce, and fried chicken dominate the market.

This seasoned chicken is manufactured by preparing the fried chicken and then mixing it with a sauce comprising corn syrup, garlic, sugar, ketchup, and the like.

However, in the case of conventional seasoned chicken, applying the sauce causes the characteristic crisp texture of the fried chicken to disappear, and also reduces the storage period due to the moisture in the sauce, resulting in limitations in its sales.

Therefore, there is a current need for a new type of method for manufacturing chicken to overcome these drawbacks.

### PRIOR ART LITERATURE

### Patent Literature

Korean Registered Patent Publication No. 10-2193535 (December 21, 2020)

### SUMMARY OF INVENTION

### Technical Problem to Be Solved

The present invention is intended to solve the above-mentioned problems, and an object thereof is to provide a method for manufacturing soup-chicken which is sterilized to improve preservability, and at the same time, can maintain a soft texture for a long time even after being mixed with a sauce using a meat tenderizing sauce.

The problems to be solved by the present invention are not limited to those mentioned above, and other problems not mentioned will be clearly understood by those skilled in the art from the following description.

### Technical Solution

A method for manufacturing soup-chicken according to the present invention, comprising: a first step of mixing 200 parts by weight of soy sauce, 100 parts by weight of soda, 100 parts by weight of water, 200 to 250 parts by weight of corn syrup, 50 parts by weight of tomato ketchup, 30 parts by weight of mixed seasoning, 30 parts by weight of minced onion, 30 parts by weight of curry, 0.5 parts by weight of minced ginger, and 0.5 parts by weight of minced Cheongyang pepper with respect to 100 parts by weight of sugar;
a second step of sterilizing the mixture mixed through the first step at a temperature of 80° C. to 90° C. for 20 minutes;
a third step of sealing the mixture sterilized through the second step in a container and aging the mixture at room temperature for 5 hours;
a fourth step of putting the aged mixture through the third step into a cauldron with fried, sectioned chicken, wherein the mixture is added in an amount corresponding to about half of the volume of the cauldron;
a fifth step of adding 6 slices of tomato, 100 g of chives cut into three sections based on a handful, 1 to 2 minced Cheongyang peppers, and half of a minced onion based on one onion, in the fourth step; and
a sixth step of boiling down the ingredients put into the cauldron through the fifth step over a low heat for 10 to 15 minutes.

### BRIEF DESCRIPTION OF DRAWINGS

FIG. 1 is a diagram illustrating the soup-chicken manufacturing method according to an embodiment of the present invention.

FIG. 2 is a diagram illustrating the container unit used in the soup-chicken manufacturing method according to an embodiment of the present invention.

### Detailed Description of Preferred Embodiments of Invention

The above drawings are provided as examples such that the idea of the present invention is sufficiently given to those skilled in the art.

Therefore, the present invention is duly not limited to the drawings proposed below but may be specified in other forms.

Further, like reference numerals denote like components throughout the specification.

Further, in order to aid understanding, it should be noted that the drawings are not necessarily proportional to scale but specific parts are enlarged or reduced in size.

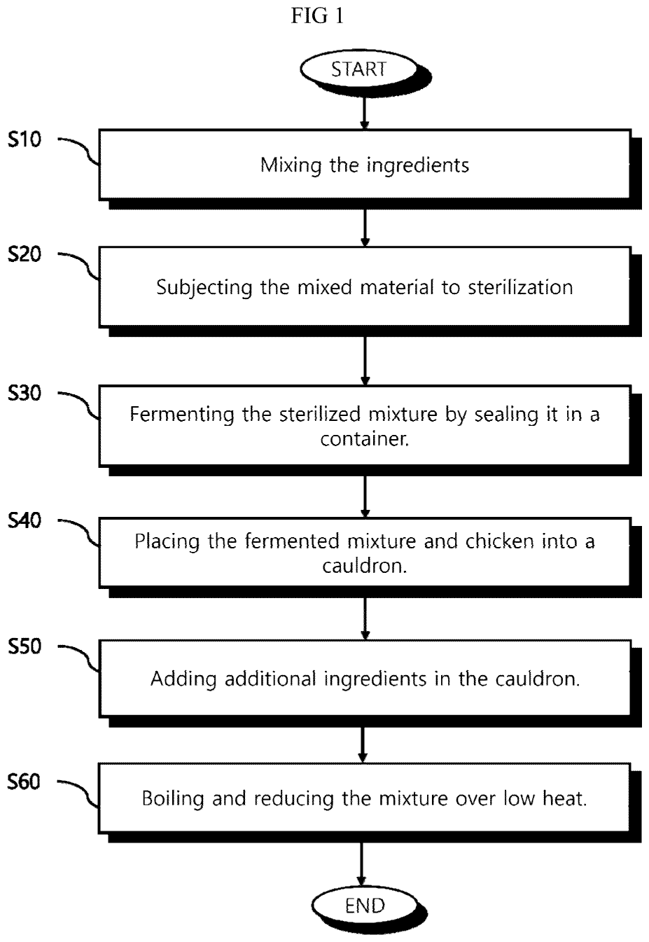

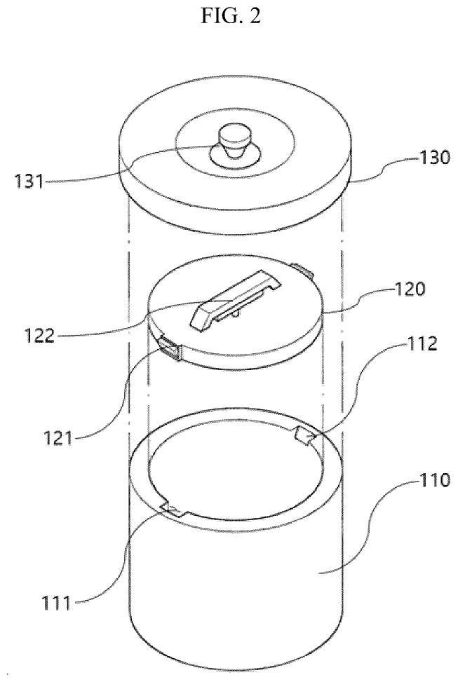

FIG. 1 is a diagram illustrating the soup-chicken manufacturing method according to an embodiment of the present invention. FIG. 2 is a diagram illustrating the container unit used in the soup-chicken manufacturing method according to an embodiment of the present invention.

The soup-chicken manufacturing method according to the present invention consists of a first step (S10) to a sixth step (S60).
Step 1 (S10): For 100 parts by weight of sugar, the following ingredients are mixed: 200 parts by weight of soy sauce, 100 parts by weight of cider, 100 parts by weight of water, 200 to 250 parts by weight of starch syrup, 50 parts by weight of tomato ketchup, 30 parts by weight of mixed seasoning, 30 parts by weight of minced onion, 30 parts by weight of curry, 0.5 parts by weight of minced ginger, and 0.5 parts by weight of minced Cheongyang chili pepper.
Step 2 (S20): The mixture mixed in Step 1 is sterilized at a temperature of 80° C. to 90° C. for 20 minutes.
Step 3 (S30): The sterilized mixture from Step 2 is sealed in the container unit (100) and aged at room temperature for 5 hours.
Step 4 (S40): In this step, the aged mixture from Step 3 is added to a cauldron containing the fried, chopped chicken, such that the mixture fills approximately half the volume of the cauldron.

Here, the chicken may include the steps of: chopping the chicken into a predetermined size; making a plurality of holes in the chopped chicken using a rod; adding a meat tenderizing sauce to the plurality of holes; and frying the chicken using frying powder. At this time, the chicken can be fried using various frying powders such as rice flour or wheat flour.

And the meat tenderizing sauce can be mixed with 10 parts by weight of pineapple extract and 10 parts by weight of kiwi extract.

And the rod (not shown) may include a central support and a plurality of leg portions. Furthermore, the rod can be operated by the user's manual force.

At this time, the rod may include a central support and a plurality of octopus-leg-shaped leg portions that are integrally extended from the lower part of the central support and are arranged at regular intervals so that a plurality of holes are pierced into the chopped chicken.

And the central support may include a gripping part coupled to the upper portion, which is held by the user. Here, the gripping part may have a plurality of protrusions formed to prevent the user from slipping off the gripping part.

Furthermore, a connection support member may be arranged inside the central support. This connection support member can connect the gripping part and the plurality of leg portions from the central support. That is, the gripping part and the plurality of leg portions can be fitted and coupled to the connection support member. As a result, a first groove into which the connection support member can be fitted and coupled may be formed inside the gripping part, and a second groove may be formed in the plurality of leg portions so that the connection support member can be fitted and coupled, and the connection support member can be fitted and coupled into the first groove and the second groove, respectively.

Additionally, the connection support member can be fixedly inserted into the interior of the central support.

Furthermore, the plurality of leg portions may include protrusion members for piercing a plurality of holes in the chopped chicken. At this time, the meat tenderizing sauce can be applied to the surface of the protrusion members, and the protrusion members with the meat tenderizing sauce applied can be re-inserted into the plurality of holes. This re-insertion process can be repeated from 1 to 5 times.

Moreover, the protrusion members can be easily detachable from the plurality of leg portions for easy cleaning. In this case, the detachment can be achieved by screw fastening.

Meanwhile, the container unit (100) may include a main body (110), a first sealing part (120), and a second sealing part (130). The main body (110) may have a seating groove (111) formed on the inner side, into which the first sealing part (120) is seated. And a seating shoulder (112) may be formed in the seating groove (111) to prevent the seating protrusion (121) from falling into the interior of the main body (110). A contact pad (not shown) may be attached to the seating shoulder (112) to be in close contact with the seating protrusion (121). The contact pad may be made of silicon or rubber.

The first sealing part (120) can seal the interior of the main body (110). Furthermore, the first sealing part (120) may include a seating protrusion (121) that is seated in the seating groove (111), a second sealing gripping part (122) which is grasped when opening and closing the first sealing part (120), and a sealing groove (not shown) into which a seal is inserted on the outer rim.

The second sealing part (130) re-seals the first sealing part (120), and may include a first sealing gripping part (131) which opens and closes the main body (110) and can be grasped during opening and closing.

### DESCRIPTION OF REFERENCE NUMERALS

100: Container Unit
110: Main Body
111: Seating Groove
112: Seating Shoulder
120: First Sealing Part
121: Seating Protrusion
122: Second Sealing Gripping Part
130: Second Sealing Part
131: First Sealing Gripping Part

1. A method for manufacturing soup-chicken comprising:
a first step of mixing 200 parts by weight of soy sauce, 100 parts by weight of soda, 100 parts by weight of water, 200 to 250 parts by weight of corn syrup, 50 parts by weight of tomato ketchup, 30 parts by weight of mixed seasoning, 30 parts by weight of minced onion, 30 parts by weight of curry, 0.5 parts by weight of minced ginger, and 0.5 parts by weight of minced Cheongyang pepper with respect to 100 parts by weight of sugar;
a second step of sterilizing the mixture mixed through the first step at a temperature of 80° C. to 90° C. for 20 minutes;
a third step of sealing the mixture sterilized through the second step in a container and aging the mixture at room temperature for 5 hours;
a fourth step of putting the aged mixture through the third step into a cauldron with fried, sectioned chicken, wherein the mixture is added in an amount corresponding to about half of the volume of the cauldron;
a fifth step of adding 6 slices of tomato, 100 g of chives cut into three sections based on a handful, 1 to 2 minced Cheongyang peppers, and half of a minced onion based on one onion, in the fourth step; and
a sixth step of boiling down the ingredients put into the cauldron through the fifth step over a low heat for 10 to 15 minutes.

2. The method for manufacturing soup-chicken of claim 1, wherein the chicken is prepared by steps comprising:
chopping the chicken into a predetermined size;
making a plurality of holes in the chopped chicken using a rod;
adding a meat tenderizing sauce to the plurality of holes; and
frying the chicken using frying powder.

3. The method for manufacturing soup-chicken of claim 2, wherein the meat tenderizing sauce is mixed with:
10 parts by weight of pineapple extract; and
10 parts by weight of kiwi extract.

4. The method for manufacturing soup-chicken of claim 2, wherein the rod includes:
a central support; and
a plurality of octopus-leg-shaped leg portions extending integrally from a lower part of the central support and arranged at regular intervals such that a plurality of holes are pierced into the chopped chicken.

5. The method for manufacturing soup-chicken of claim 4,
wherein the central support includes a gripping part coupled to an upper portion and grasped by a user; and
the gripping part has a plurality of protrusions formed thereon to prevent the user from slipping off the gripping part.

6. The method for manufacturing soup-chicken of claim 4, wherein the plurality of leg portions includes a protrusion member for piercing a plurality of holes in the chopped chicken.

7. The method for manufacturing soup-chicken of claim 6, wherein the protrusion member has the meat tenderizing sauce applied to its surface, and the protrusion member with the meat tenderizing sauce applied is re-inserted into the plurality of holes.

8. The method for manufacturing soup-chicken of claim 1, wherein the container unit comprises:
a main body;
a first sealing part for sealing an interior of the main body; and
a second sealing part for re-sealing the first sealing part, the second sealing part further having a first sealing gripping part for opening and closing the main body and for gripping during opening and closing.

9. The method for manufacturing soup-chicken of claim 8, wherein the main body has a seating groove formed on an inner side, in which the first sealing part is seated.

10. The method for manufacturing soup-chicken of claim 9, wherein the first sealing part includes:
a seating protrusion seated in the seating groove;
a second sealing gripping part for gripping the first sealing part during opening and closing; and
a sealing groove in an outer rim, into which a seal is inserted.
